(19) United States
(12) Patent Application Publication
(10) Pub. No.: US 2004/0006717 A1
(43) Pub. Date: Jan. 8, 2004

(54) Data preservation

(76) Inventor: Gunter Plappert, Pfedelbach (DE)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/191,181

(22) Filed: Jul. 8, 2002

(51) Int. Cl. G06F 1/26

(52) U.S. Cl. 713/300

(57) ABSTRACT

In one embodiment, a method is provided. The method of this embodiment may include determining, by circuitry that is capable of being coupled to an interface, characteristics of electrical power and a clock signal being transmitted via the interface to the circuitry. The method of this embodiment may also include determining, by the circuitry, based at least in part upon whether a level of at least one of the characteristics is below a predetermined level, whether to transmit other electrical power and another clock signal, generated by the circuitry, to a memory comprised in the circuitry. Of course, many variations, modifications, and alternatives are possible without departing from this embodiment.

### CROSS-REFERENCE TO RELATED APPLICATION

The subject application is related to co-pending U.S. Patent Application Serial No. Yet To Be Assigned (Attorney Docket No. P13536), entitled “Data Preservation,” which is being filed concurrently with the subject application and is assigned to the same Assignee as the subject application.

### FIELD

This disclosure relates to data preservation.

### BACKGROUND

The speed of access of data stored in cache memory may be significantly greater than the speed of access of data stored in disk storage. However, per unit of storage, cache memory may be more expensive than disk storage. Accordingly, in a data storage system that includes both cache memory and disk storage, the storage capacity of the cache memory may be less than the storage capacity of the disk storage. When the data storage system receives a request to access data stored in the system, the system may determine whether the request can be satisfied using data stored in the cache memory. If the request can be satisfied with data stored in the cache memory, the system may attempt to satisfy the request using the data stored in the cache memory. Conversely, if the request cannot be satisfied using the data in the cache memory, the system may satisfy the request using data stored in disk storage.

The cache memory may comprise circuitry that may periodically refresh the data stored in the cache memory in order to maintain the data's integrity. If the electrical power or clock signal provided to the cache memory is interrupted, the cache memory may be unable to refresh the data stored in the cache memory. This may result in corruption and/or loss of the data stored in the cache memory.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIGS. 1 and 2 are diagrams illustrating system embodiments.

FIG. 3 is a diagram illustrating circuitry that may be comprised in a circuit card according to an embodiment.

FIGS. 4 is a flowchart illustrating operations that may be performed according to an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

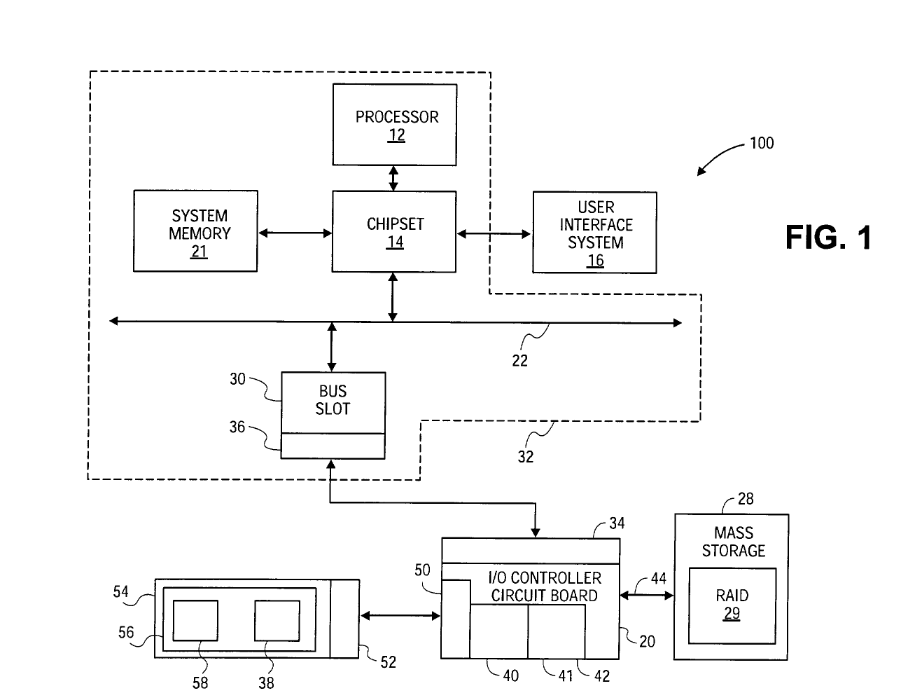

FIG. 1 illustrates a system embodiment 100. System 100 may include a host processor 12 coupled to a chipset 14. Host processor 12 may comprise, for example, an Intel® Pentium® III or IV microprocessor that is commercially available from the Assignee of the subject application. Of course, alternatively, host processor 12 may comprise another type of microprocessor, such as, for example, a microprocessor that is manufactured and/or commercially available from a source other than the Assignee of the subject application, without departing from this embodiment.

Chipset 14 may comprise a host bridge/hub system that may couple host processor 12, a system memory 21 and a user interface system 16 to each other and to a bus system 22. Chipset 14 may also include an I/O bridge/hub system (not shown) that may couple the host bridge/bus system to bus 22. Chipset 14 may comprise integrated circuit chips, such as those selected from integrated circuit chipsets commercially available from the assignee of the subject application (e.g., graphics memory and I/O controller hub chipsets), although other integrated circuit chips may also, or alternatively be used, without departing from this embodiment. Additionally, chipset 14 may include an interrupt controller (not shown) that may be coupled, via one or more interrupt signal lines (not shown), to other components, such as, e.g., I/O controller circuit board 20, when board 20 is inserted into circuit board bus extension slot 30. This interrupt controller may process interrupts that it may receive via these interrupt signal lines from other components in system 100. User interface system 16 may comprise, e.g., a keyboard, pointing device, and display system that may permit a human user to input commands to, and monitor the operation of, system 100.

Bus 22 may comprise a bus that complies with the Peripheral Component Interconnect (PCI) Local Bus Specification, Revision 2.2, Dec. 18, 1998 available from the PCI Special Interest Group, Portland, Oreg., U.S.A. (hereinafter referred to as a “PCI bus”). Alternatively, bus 22 instead may comprise a bus that complies with the PCI-X Specification Rev. 1.0a, Jul. 24, 2000, available from the aforesaid PCI Special Interest Group, Portland, Oreg., U.S.A. (hereinafter referred to as a “PCI-X bus”). Also alternatively, bus 22 may comprise other types and configurations of bus systems, without departing from this embodiment.

I/O controller board 20 may be coupled to and control the operation of a set of one or more magnetic disk, optical disk, solid-state, and/or semiconductor mass storage devices (hereinafter collectively or singly referred to as “mass storage 28”). In this embodiment, mass storage 28 may comprise, e.g., one or more redundant arrays of inexpensive disks (RAID) 29.

Processor 12, system memory 21, chipset 14, PCI bus 22, and slot 30 may be comprised in a single circuit board, such as, for example, a system motherboard 32. Mass storage 28 may be comprised in one or more respective enclosures that may be separate from the enclosure in which the motherboard 32 and the components comprised in the motherboard 32 are enclosed.

Depending upon the particular configuration and operational characteristics of mass storage 28, I/O controller board 20 may be coupled to mass storage 28 via one or more network communication links or media 44. Board 20 may exchange data and/or commands with mass storage 28, via links 44, using any one of a variety of different communication protocols, e.g., a Small Computer Systems Interface (SCSI), Fibre Channel (FC), Ethernet, Serial Advanced Technology Attachment (S-ATA), or Transmission Control Protocol/Internet Protocol (TCP/IP) communication protocol. Of course, alternatively, I/O controller board 20 may exchange data and/or commands with mass storage 28 using other communication protocols, without departing from this embodiment of the claimed subject matter.

In accordance with this embodiment, a SCSI protocol that may be used by controller board 20 to exchange data and/or commands with mass storage 28 may comply or be compatible with the interface/protocol described in American National Standards Institute (ANSI) Small Computer Systems Interface-2 (SCSI-2) ANSI X3.131-1994 Specification. If a FC protocol is used by controller board 20 to exchange data and/or commands with mass storage 28, it may comply or be compatible with the interface/protocol described in ANSI Standard Fibre Channel (FC) Physical and Signaling Interface-3 X3.303:1998 Specification. Alternatively, if an Ethernet protocol is used by controller board 20 to exchange data and/or commands with mass storage 28, it may comply or be compatible with the protocol described in Institute of Electrical and Electronics Engineers, Inc. (IEEE) Std. 802.3, 2000 Edition, published on Oct. 20, 2000. Further, alternatively, if a S-ATA protocol is used by controller board 20 to exchange data and/or commands with mass storage 28, it may comply or be compatible with the protocol described in “Serial ATA: High Speed Serialized AT Attachment,” Revision 1.0, published on Aug. 29, 2001 by the Serial ATA Working Group. Also, alternatively, if TCP/IP is used by controller board 20 to exchange data and/or commands with mass storage 28, it may comply or be compatible with the protocols described in Internet Engineering Task Force (IETF) Request For Comments (RFC) 791 and 793, published September 1981.

Slot 30 may comprise a PCI expansion slot that comprises a PCI bus connector or interface 36. Connector 36 may be electrically and mechanically mated with a PCI bus connector or interface 34 that is comprised in circuit board 20. Circuit board 20 may comprise operative circuitry 42. Circuitry 42 may comprise I/O processor 40 and computer-readable memory 41. Depending upon the particular embodiment, memory 41 may comprise one or more of the following types of computer-readable memories: semiconductor firmware memory, programmable memory, non-volatile memory, read only memory, electrically programmable memory, random access memory, cache memory, flash memory, magnetic disk memory, and/or optical disk memory. Additionally, it should be appreciated that, either additionally or alternatively, memory 41 may comprise other and/or later-developed types of computer-readable memory. Processor 40 may include integrated circuit chips (not shown) comprised in an integrated circuit chipset, such as those commercially available from the Assignee of the subject application (e.g., the Intel® 80310 Chipset). Alternatively, processor 40 instead may comprise other integrated circuit chips (e.g., the Intel® 80960 RM/RN I/O processor, the Intel® 80321 processor, and/or other types of processors that are available from sources other than the Assignee of the subject application), or other types of processors/integrated circuits without departing from this embodiment of the claimed subject matter.

Machine-readable program instructions may be stored in computer-readable memory 41. These instructions may be accessed and executed by processor 40. When executed by processor 40, these instructions may result in processor 40 performing the operations described herein as being performed by processor 40.

Of course, the operative circuitry 42 described herein as being comprised in board 20, need not be comprised in board 20, but instead, without departing from this embodiment, may be comprised in other structures, systems, and/or devices that may be, for example, comprised in motherboard 32, coupled to bus 22, and exchange data and/or commands with other components in system 100.

System 100 may also include a circuit card 54. Card 54 may include operative circuitry 56. Operative circuitry 56 may include control and power circuitry (collectively referred to by reference number 58) and cache memory 38. In this embodiment, cache memory 38 may comprise one or more synchronous dynamic random access memory (SDRAM) semiconductor memory devices. Alternatively or additionally, cache memory 38 may comprise magnetic disk and/or optical disk memory.

Slot 30 and board 20 may be constructed to permit board 20 to be inserted into slot 30. When board 20 is properly inserted into slot 30, connectors 34 and 36 may become electrically and mechanically coupled to each other. When connectors 34 and 36 are so coupled to each other, board 20 may become electrically coupled to bus 22.

Board 20 also may include another card slot or interface 50. Card 54 may include a connector or interface 52. In this embodiment, card 54 may comprise a Dual or Single In-line Memory Module (DIMM or SIMM, respectively) connector 52, and slot 50 may comprise a DIMM or SIMM socket. Slot 50 and connector 52 may be constructed to permit card 54 to be inserted into slot 50. When card 54 is properly inserted into slot 50, slot 50 and connector 52 may become electrically and mechanically coupled to each other. When slot 50 and connector 52 are so coupled to each other, card 54 may become electrically coupled to board 20.

In one mode of operation of circuit card 54, when card 54 and board 20 are so coupled to each other, processor 40 in controller board 20 may be capable of exchanging data and/or commands with circuitry 56 in card 54. This may result in cache memory 38 storing data in and/or retrieving data from cache memory 38. Processor 40 in board 20 may also be capable of exchanging data and/or commands with mass storage 28 that may result in data being stored in and/or retrieved from RAID 29. At least a portion of the data that may be stored in and/or retrieved from cache memory 38 as a result of the exchange of data and/or commands between processor 40 and circuitry 56 may be data to be written or de-staged to mass storage 28 and/or RAID 29.

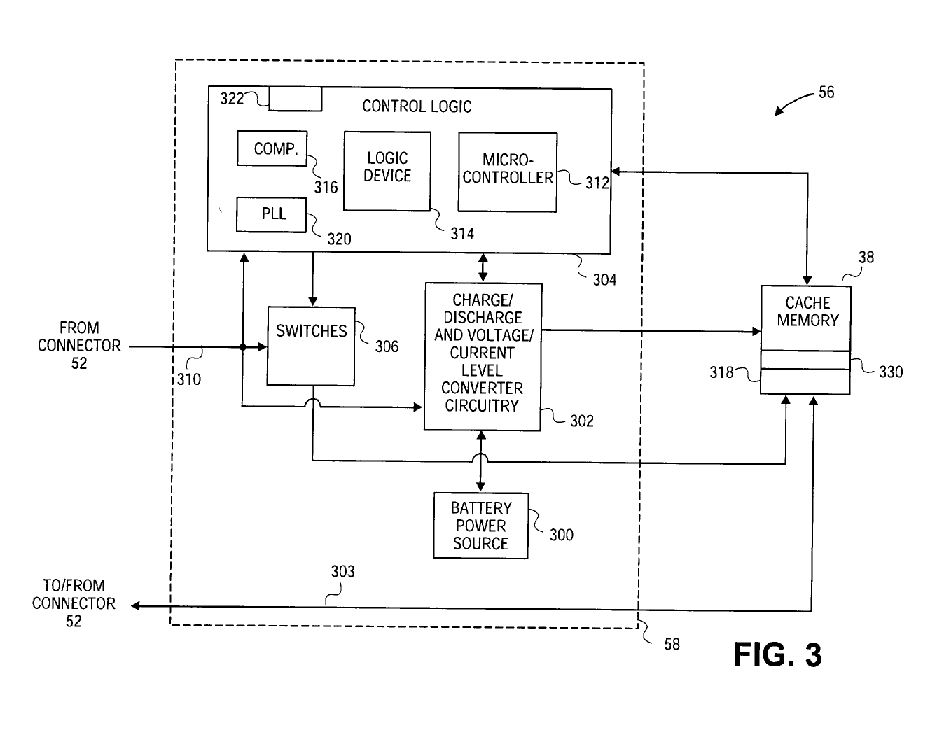

As shown in FIG. 3, circuitry 58 may include control logic circuitry 304, rechargeable battery power source 300, a plurality of controllable switches 306, and circuitry 302. Cache memory 38 may be electrically coupled to control logic 304 and circuitry 302. Cache memory 38 may also be electrically coupled to address and data signal lines 303. When card 54 is coupled to board 20, circuitry 42 may propagate to circuitry 56 control, power, and clock signals via control, power, and clock signal lines (collectively referred to by numeral 310 in FIG. 3), interface 50, and connector 52. Also when card 54 is coupled to board 20, circuitry 42 may propagate to cache memory 38 address and/or data signals via lines 303, interface 50, and connector 52. The control signal lines in lines 310 may comprise conventional 12C interface lines.

Control logic circuitry 304 may comprise micro-controller 312, logic device 314, comparator 316, phase lock loop (PLL) circuitry 320, and local oscillator/clock signal generator circuitry 322. Micro-controller 312 may comprise, for example, a PIC 16F874 micro-controller that is commercially available from Microchip Technology, Inc. of Chandler, Ariz., United States of America. Logic device 314 may comprise a complex programmable logic device (CPLD) that may include sequential and/or state machine logic (not shown). Logic device 314 and/or micro-controller 312 may receive and utilize in their respective operations and/or processing a clock signal generated by local oscillator 322. Alternatively or additionally, micro-controller 312 and/or logic device 314 may comprise other types of circuitry, including, e.g., processors and/or other integrated circuits commercially available from the Assignee of the subject application, without departing from this embodiment. Although not shown in the Figures, control logic 304 may also include read only, and/or random access memory that may contain, e.g., program instructions and/or data structures that may be accessed and executed by micro-controller 312 and/or logic device 314 to facilitate and/or enable micro-controller 312 and/or logic device 314 to carry out the operations described herein as being carried out by micro-controller 312 and/or logic device 314. The clock signal generated by local oscillator 322 may have a frequency and amplitude that are substantially the same as the frequency and amplitude of the clock signal that may be propagated to circuitry 56, when card 54 is coupled to board 20, via the clock signal line comprised in lines 310. Alternatively, without departing from this embodiment, the amplitude and/or frequency of the clock signal generated by local oscillator 322 may be different from the amplitude and/or frequency of the clock signal that may be propagated via the clock signal line in lines 310.

The control, power, and clock signals propagated to circuitry 56 via lines 310 may be received by control logic 304. In addition, the subset of lines 310 that is used to propagate control and power signals may also be coupled to cache memory 38 via switches 306. That is, in circuitry 56, each of the signal lines 310 (except for the clock signal line comprised in lines 310, which clock signal line is not shown separately in the Figures) may be coupled to a respective one of switches 306. When a switch in switches 306 is closed, the respective signal that may be propagated via the respective signal line that is coupled to that switch is permitted to propagate to cache memory 38. Conversely, when a respective switch in switches 306 is open, the respective signal that may be propagated via the respective signal line that is coupled to that respective switch is prevented from propagating to cache memory 38. The respective states of each of switches 306 may be controlled by logic device 314. As used herein, the “state” of a switch refers to whether the switch is open (i.e., in a state that does not permit conduction of current through the switch) or closed (i.e., in a state that permits conduction of current through the switch).

The power signal line (not shown separately in the Figures) comprised in lines 310 also may be coupled to circuitry 302. In accordance with control signals supplied to circuitry 302 from micro-controller 312, circuitry 302 may control the charging of rechargeable power source 300 with electrical power that may be supplied to circuitry 56 via the power signal line comprised in lines 310. Additionally, in accordance with such control signals, circuitry 302 may control the discharging from power source 300 of electrical power that may be stored in power source 300 to provide actuating electrical power to control logic 304 and/or cache memory 38. Circuitry 302 also may include circuitry to convert the voltage and/or current levels of the electrical power supplied from power source 300 and/or via the power signal line comprised in lines 310 into appropriate current and/or voltage levels to power control logic 304 and/or cache memory 38 and to charge the power source 300.

Power source 300 may comprise one or more rechargeable batteries. For example, in this embodiment, power source 300 may comprise two AAA-size nickel metal hydride (Ni-MH) rechargeable batteries coupled together in series. Each of these batteries may have, for example, a maximum charge capacity of 700 milliamp-hours (mAh) and a nominal voltage of 2.4 volts. Of course, power source 300 may comprise other types of rechargeable batteries and/or power sources without departing from this embodiment.

In one mode of operation of circuitry 56, the clock signal that may be supplied to logic 304 via the clock signal line in lines 310 may be used as the reference clock signal for PLL 320. That is, in one mode of operation of circuitry 56, the reference signal to which the output signal of PLL 320 is “locked” may be the clock signal that may be supplied to logic 304 via the clock signal line in lines 310. Thus, in this mode of operation, the phase, frequency, and amplitude of the output signal produced by PLL 320 may be substantially the same as the phase, frequency, and amplitude of the clock signal that is supplied to logic 304 via the clock signal line in lines 310. In this mode of operation, the output of PLL 320 is provided as an input clock signal to cache memory 38. Also in this mode of operation, switches 306 may be closed, thereby coupling the control and power signal lines of lines 310 to cache memory 38. In this mode of operation, respective portions of the power supplied to the circuitry 56 via the power signal line in lines 310 may be used to provide actuating electrical power to control logic 304 and cache memory 38, and to charge power source 300 (e.g., until power source 300 is fully charged to its maximum charge storage capacity).

Conversely, in another mode of operation of circuitry 56, the clock signal that is supplied to logic 304 via the clock signal line in lines 310 may not be used as the reference clock signal for PLL 320. Instead, the clock signal that is generated by local oscillator 322 may be used as the reference clock signal for PLL 320. That is, in this other mode of operation of circuitry 56, the reference signal to which the output signal of PLL 320 is “locked” may be the clock signal that is generated by local oscillator 322. Thus, in this other mode of operation, the phase, frequency, and amplitude of the output signal produced by PLL 320 may be substantially the same as the phase, frequency, and amplitude of the clock signal that is generated by local oscillator 322, and this output signal from PLL 320 may be provided as an input clock signal to cache memory 38. Also in this other mode of operation, switches 306 may be opened, thereby de-coupling the control and power signal lines of lines 310 from cache memory 38. In this other mode of operation, power previously stored in power source 300 may be discharged from power source 300 to power cache memory 38 and control logic 304. Logic device 314 may be capable of providing a control signal to, e.g., a controllable switch (not shown) in PLL 320 that may control whether the reference signal that is provided to PLL 320 is the clock signal that may be provided to circuitry 56 via connector 52 or the clock signal generated by local oscillator 322.

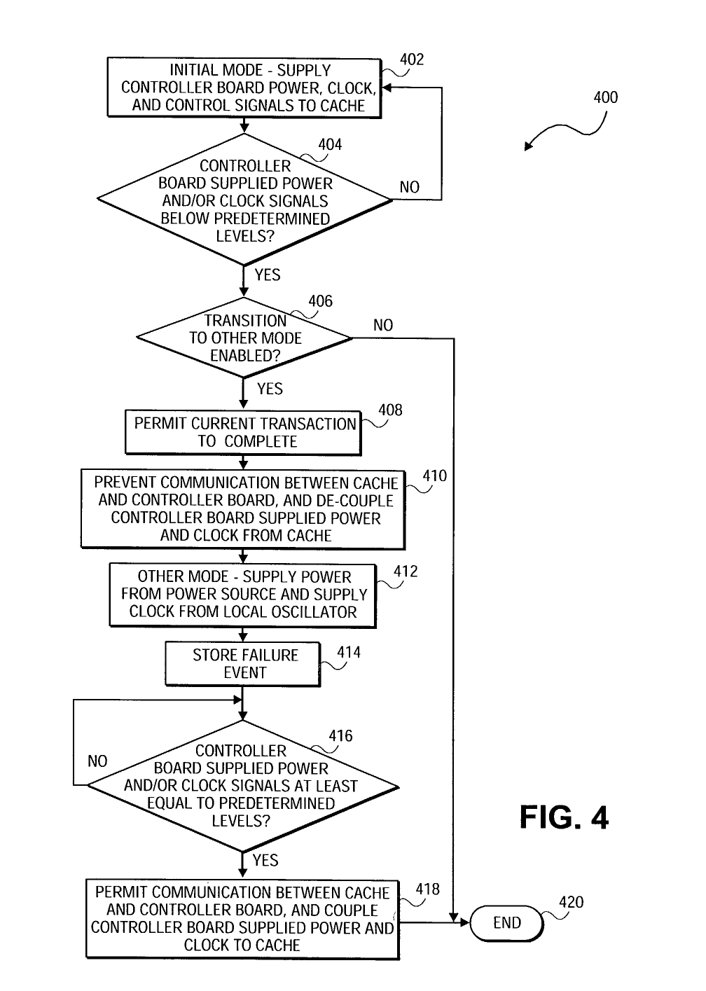

These and other operations 400 that may be carried out in system 100 in accordance with one embodiment will now be described with reference to FIG. 4. It is assumed for purposes of the present example that, prior to commencement of operations 400, card 54 has been properly coupled to board 20, board 20 has been properly coupled to slot 30, a reset of system 100 has occurred, and system 100 and board 20 are functioning properly. After such reset, board 20 may supply to circuitry 56 control, power, and clock signals via lines 310. Initially, circuitry 54 may enter an initial mode of operation in which logic device 314 may provide control signals to switches 306 that may result in switches 306 coupling the power and control signal lines in lines 310 to cache memory 38, and logic device 314 may signal PLL 320 to use as its reference signal the clock signal provided via the clock signal line in lines 310, as illustrated by operation 402 in FIG. 4. Comparator 316 in circuitry 304 may monitor the magnitude or level of the voltage that is being supplied to circuitry 56 via the power signal line in lines 310, and may detect whether the magnitude or level of this voltage is at least equal to a predetermined minimum magnitude or level. If the magnitude or level of this voltage is at least equal to the predetermined minimum magnitude or level, this may indicate that the magnitude or level of the electrical power that is being supplied to the circuitry 56 by this power line is at least equal to a predetermined minimum magnitude or level of power sufficient to permit circuitry 56 to function properly. That is, board 20 may be designed to supply to circuitry 56 electrical energy at direct current (DC) voltage and current levels that together provide sufficient electrical power to permit circuitry 56 to function as desired. Comparator 316 may detect whether the voltage level being supplied to circuitry 56 from board 20 is below the predetermined minimum level, and comparator 316 may provide logic device 314 with a signal that indicates whether this voltage level is below the predetermined minimum level. When this voltage level is below the predetermined minimum level, this may be an indication that the level of electrical power being supplied to circuitry 56 via this power signal line is below a predetermined minimum power level that is sufficient to permit circuitry 56 to function properly. This may indicate that an interruption in the supply of actuating electrical power from controller board 20 to circuitry 56 may have occurred. Such an interruption in the supply of actuating electrical power from controller board 20 may occur as a result of, for example, an operational failure of controller board 20 (i.e., a failure of controller board 20 to operate as expected). Thus, based upon the signal provided to logic device 314 by comparator 316, logic device 314 may be able to determine whether the electrical power being supplied to circuitry via the power signal line in lines 310 is below this predetermined minimum power level.

Additionally, logic device 314 may monitor the clock signal supplied to circuitry 56 via the clock signal line in lines 310, and may determine the slope of this clock signal. Logic device 314 may also determine whether the magnitude of the slope of this clock signal remains below a predetermined minimum threshold level for longer than a predetermined amount of time. If the magnitude of this clock signal remains below this predetermined minimum threshold level for longer than this predetermined amount of time, this may indicate that this clock signal cannot be used by cache memory 38 in and/or to facilitate operations carried out by cache memory 38, such as, for example, to refresh data stored in cache memory 38. This may indicate that an interruption in the supply of the clock signal from controller board 20 may have occurred. Such an interruption in the supply of the clock signal from controller board 20 may occur as a result of, for example, an operational failure of controller board 20.

Thus, in this embodiment, logic device 314 may determine characteristics of the electrical power and the clock signal being supplied to circuitry 56 via the power supply and clock signal lines in lines 310. The characteristic of the electrical power that may be so determined by logic device 314 may comprise, for example, the level or magnitude of the electrical power and/or the voltage provided to circuitry 56 via the power supply line in lines 310. The characteristic of the clock signal that may be so determined by logic device 314 may comprise, for example, the slope of the clock signal. Logic device 314 may determine whether the respective level or magnitude of the power being supplied to circuitry 56 via the power signal line in lines 310 and of the is below the predetermined minimum power level that is sufficient to permit circuitry 56 to function properly, as illustrated by operation 404 in FIG. 4. Also as part of operation 404, logic device 314 may determine whether the magnitude of the slope of the clock signal being supplied to circuitry 56 via the clock signal line in line 310 remains below the predetermined minimum threshold level for longer than the predetermined amount of time.

If, as a result of operation 404, logic device 314 determines that the level of power being supplied to circuitry 56 via the power signal line in lines 310 is at least equal to this predetermined minimum power level and the magnitude of the slope of the clock signal being supplied to circuitry 56 via the clock signal line in lines 310 has not remained below this predetermined minimum threshold level for longer than the predetermined amount of time, circuitry 56 may remain in its initial mode of operation. In this initial mode of operation, the clock signal that is supplied to logic 304 via the clock signal line in lines 310 is used as the reference clock signal for PLL 320, and switches 306 may be closed. Also in this initial mode of operation, respective portions of the power supplied to the circuitry 56 via the power signal line in lines 310 may be used to provide actuating electrical power to control logic 304 and cache memory 38, and to charge power source 300 (e.g., until power source 300 is fully charged to its maximum charge storage capacity). While in this initial mode of operation, logic device 314 may continue to periodically determine whether the level of power being supplied to circuitry 56 via this power signal line is at least equal to this predetermined minimum power level and/or whether the magnitude of the slope of this clock signal has not remained below this predetermined minimum threshold level for longer than the predetermined amount of time.

Conversely, if, as a result of operation 404, logic device 314 determines that the level of power being supplied to circuitry 56 via the power signal line is below this predetermined minimum power level and/or that the magnitude of the slope of this clock signal remains below the predetermined minimum threshold level for longer than the predetermined amount of time, logic device 314 may signal micro-controller 312. This may result in micro-controller 312 signaling cache memory 38. This may result in cache memory 38 retrieving from one or more predetermined memory locations 318 in cache memory 38 one or more values stored therein and providing these one or more values to micro-controller 312. Micro-controller 312 may examine these one or more values to determine whether circuitry 56 is enabled to enter its other mode of operation, as illustrated by operation 406 in FIG. 4. That is, processor 40 in board 20 may supply circuitry 56 (e.g., via the control lines in lines 310 and the address and data lines 303) with signals via, e.g., the control signal lines in lines 310 and/or address and data lines 303 that may result in cache memory 38 storing in one or more locations 318 the one or more values. These one or more values may indicate whether circuitry 56 is permitted to enter this other mode of operation. If, as a result of examining these one more values, micro-controller 312 determines that these one or more values indicate that circuitry 56 is permitted to enter this other mode of operation, micro-controller 312 may determine, as a result of operation 406, that circuitry 56 is enabled to enter this other mode of operation.

Conversely, if as a result of examining these one more values, micro-controller 312 determines that these one or more values do not indicate that circuitry 56 is permitted to enter this other mode of operation, micro-controller 312 may determine, as a result of operation 406, that circuitry 56 is not enabled to enter this other mode of operation. If, as a result of operation 406, micro-controller 312 determines that circuitry 56 is not enabled to enter its other mode of operation, circuitry 56 may remain in its present, initial mode of operation, and processing associated with operations 400 may terminate, as illustrated by operation 420.

Logic device 314 may be able to snoop the control signals being propagated through the control signal lines of lines 310 to determine when transactions involving cache memory 38 and controller board 20 are underway (e.g., currently in process and/or currently pending completion). As used herein, transactions involving a memory device may include operations that may permit another device to access one or more memory locations in the memory device, such as, for example, operations to read data stored in one or more such memory locations and/or operations to write data to one or more such memory locations. If, as a result of operation 406, micro-controller 312 determines that circuitry 56 is enabled to enter its other mode of operation, micro-controller 312 may signal logic device 314. This may result in logic device 314 examining the control signals currently being propagated through the control signal lines of lines 310 to determine whether a transaction involving cache memory 38 and controller board 20 is currently underway. If, as a result of its examination of such control signals, logic device 314 determines that such a transaction is currently underway, logic device 314 may permit this transaction to complete, as illustrated by operation 408. Thereafter, logic device 314 may prevent communication (e.g., via one or more of the control signal lines in lines 310) between cache memory 38 and controller board 20, and may de-couple from cache memory 38 the power and clock signals provided to circuitry 56 from controller board 20, as illustrated by operation 410 in FIG. 4. Logic device 314 may accomplish this by first signaling switches 306 to de-couple one or more of the control signal lines in lines 310 from cache memory 38. Logic device 314 then may wait for a predetermined period of time to elapse, such as, for example, eight clock pulses of local oscillator 322. Logic device 314 may then signal switches 306 to de-couple the power signal line in lines 310 from cache memory 38. As a result of logic device 314 signaling switches 306 in this manner, switches 306 may de-couple control and power signal lines of lines 310 from cache memory 38. This may prevent processor 40 in controller board 20 from being able to communicate with and/or access data stored in cache memory 38.

Contemporaneously, actuating electrical power may be supplied to cache memory 38 and control logic 304 from power source 300, and a clock signal may be supplied to cache memory 38 that may be generated internally to circuit card 54, as illustrated by operation 412 in FIG. 4. More specifically, logic device 314 may signal PLL 320 to use as its reference signal the clock signal that is supplied from oscillator 322 to logic device 314. This may result in the phase, frequency, and amplitude of the output signal produced by PLL 320 being substantially the same as the phase, frequency, and amplitude of the clock signal that is generated by local oscillator 322, and this output signal from PLL 320 may be provided as the clock signal input to cache memory 38. Additionally, micro-controller 312 may signal circuitry 302 to supply actuating electrical power from power source 300 to cache memory 38 and to control logic 304. This may result in actuating electrical power being supplied from power source 300 to cache memory 38 and control logic 304. Although not shown in the Figures, control logic 304 may include not shown charge storage circuitry from which stored electrical power may be discharged to power control logic 304 during the time between completion of operation 404 and completion of operation 412. Also, as part of operation 412, micro-controller 312 may signal cache memory 38. This may result in cache memory 38 periodically refreshing data stored in cache memory 38 using the electrical power from source 300 and the clock signal generated by PLL 320 based upon the clock signal generated by oscillator 322. Alternatively, as part of operation 412, micro-controller 312 may signal cache memory 38. This may result in cache memory 38 entering a mode of operation in which cache memory 38 may periodically refresh data stored in cache memory 38 using the electrical power from source 300 and a clock signal generated by a clock signal generator (not shown) that may be comprised in cache memory 38. In this alternative arrangement, micro-controller 312 may comprise another clock signal generator (not shown) that may generate a clock signal that may be utilized by micro-controller 312 after completion of operation 412 and/or when cache memory 38 is in this mode of operation. Thus, as a result of operation 412, data stored in cache memory 38 may be preserved despite interruption of actuating electrical power and/or clock signals supplied from controller board 20 to circuitry 56.

After operation 412 has been completed, micro-controller 312 may signal cache memory 38. This may result in cache memory 38 storing in one or more memory locations 330 in cache memory 38 one or more values that may indicate that a possible operational failure of controller board 20 may have occurred and that circuitry 56 is not operating in its initial mode of operation, but instead, is operating in its other mode of operation, as illustrated by operation 414 in FIG. 4.

Thereafter, logic device 314 may continue to periodically determine whether the level of power being supplied to circuitry 56 via the power signal line in lines 310 has changed so as to be at least equal to the predetermined minimum power level sufficient to power circuitry 56, and whether the magnitude of the slope of the clock signal being supplied to circuitry 56 has changed so as to be at least equal to the predetermined minimum threshold level, as illustrated by operation 416 in FIG. 4. If, as a result of operation 416, logic device 314 determines that either the level of power being supplied to circuitry 56 via the power signal line in lines 310 is not at least equal to the predetermined minimum power level sufficient to power circuitry 56 or the magnitude of the slope of the clock signal being supplied to circuitry 56 is not at least equal to the predetermined minimum threshold level, circuitry 56 may remain in its other mode of operation. However, if the level of power being supplied to circuitry 56 via the power signal line in lines 310 is at least equal to the predetermined minimum power level sufficient to power circuitry 56 and the magnitude of the slope of the clock signal being supplied to circuitry 56 is at least equal to the predetermined minimum threshold level, this may indicate that the interruption in the supply of the power and clock signals to circuitry 56 via connector 52 may have ceased. Such cessation in the interruption in the supply of power and clock signals to circuitry 56 via connector 52 may result from, for example, corrective action being taken to correct operational failure of controller board 20.

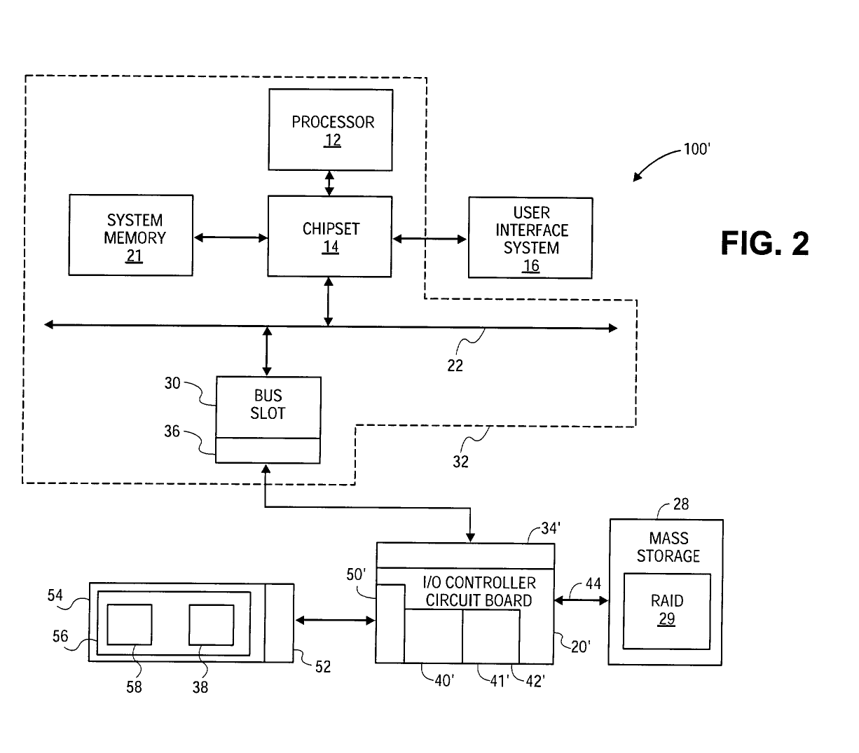

For example, in accordance with this embodiment, after circuitry 56 has completed operation 414, a human operator (not shown) may take such corrective action by physically de-coupling connector 52 from socket 50, physically de-coupling connectors 34 and 36 from each other, and physically de-coupling links 44 from controller board 20. Thereafter, as shown in FIG. 2, the human operator may physically couple a connector 34′ of another I/O controller board 20′ to connector 36, physically couple links 44 to board 20′, and physically couple connector 52 into socket 50′ of board 20′. Elements 34′, 40′, 41′, 42′, and 50′ in board 20′ may have substantially the same operation and construction as elements 34, 40, 41, 42, and 50, respectively, in board 20. Board 20′ may be known not to be suffering from an operational failure.

After such corrective action has been taken, if, as a result of operation 416, logic device 314 determines that the level of power being supplied to circuitry 56 via the power signal line in lines 310 is at least equal to the predetermined minimum power level sufficient to power circuitry 56, and the magnitude of the slope of the clock signal being supplied to circuitry 56 is at least equal to the predetermined minimum threshold level, circuitry 56 may re-enter its initial mode of operation. In order to accomplish this, logic device 314 may permit communication (e.g., via one or more of the control signal lines in lines 310) between cache memory 38 and controller board 20′, may couple to cache memory 38 the power provided to circuitry 56 from controller board 20′, and may provide to cache memory 38 the clock signal that is provided to circuitry 56 from controller board 20′, as illustrated by operation 418 in FIG. 4. Logic device 314 may accomplish this by signaling switches 306 to couple the control and power signal lines of lines 310 to cache memory 38. Additionally, logic device 314 may signal PLL 320 to use as its reference signal the clock signal that is supplied from controller board 20′. This may result in the phase, frequency, and amplitude of the output signal produced by PLL 320 being substantially the same as the phase, frequency, and amplitude of the clock signal that is supplied to circuitry 56 via the clock signal line in lines 310, and this output signal from PLL 320 may be provided as the clock signal input to cache memory 38.

Contemporaneously, logic device may signal micro-controller 312. This may result in micro-controller 312 a resetting of micro-controller 312, after which, micro-controller 312 may signal circuitry 302 and cache memory 38. As a result of the signaling of circuitry 302 by micro-controller 312, circuitry 302 may cease supplying to circuitry 304 and cache memory 38 actuating electrical power source 300, and instead such actuating electrical power may be supplied from controller board 20′. Additionally, a portion of the electrical power supplied to circuitry 56 from board 20′ may be used by circuitry 302 to re-charge power source 300. As a result of the signaling of cache memory 38 by micro-controller 312, cache memory 38 may enter a mode of operation in which refreshing of data stored in cache memory 38 may be based upon, at least in part, control signals supplied to cache memory 38 from controller 20′. In this mode of operation of cache memory 38, power and clock signals supplied to cache memory 38 from controller 20′ are used to carry out such refreshing of the data stored in cache memory 38.

Alternatively, in order to enable circuitry 56 to re-enter its initial mode of operation, controller board 20′ may supply to circuitry 56, via one or more of the control lines comprised in lines 310, a predetermined command code or value. This predetermined command code or value may be, for example, a command code or value associated with and/or requesting execution of a predetermined cache memory write operation. That is, in accordance with this alternative, after circuitry 56 has entered its other mode of operation, it may not again re-enter its initial mode of operation unless it is supplied with the predetermined command code or value. According to this alternative, after board 20′ has supplied circuitry 56 with the predetermined command code, circuitry 56 may perform operation 418 in the manner described previously.

After operation 418 has been completed, the processing comprised in operations 400 may terminate with circuitry 56 returning to its initial mode of operation, as indicated by operation 420. While circuitry 56 is again in its initial mode of operation, processor 40′ in controller board 20′ may access and examine the one or more data values stored in one or more memory locations 330. Based at least in part upon its examination of these one or more values, processor 40′ in controller board 20′ may determine that circuitry 56 previously was in its other mode of operation, and as a result, cache memory 38 may contain “dirty” data. Data in cache memory 38 is considered to be “dirty,” if, mass storage 28 does not contain corresponding user data that is identical to that data in cache memory 38. Processor 40′ then may signal board 20′. This may result in board 20′ signaling cache memory 38. In response, cache memory 38 may retrieve and transmit to board 20′ all, or at least a portion of the data stored in cache memory 38, including at least a portion of the dirty data in cache memory 38. Processor 40′ may examine and perform one or more tests on the data, or at least a portion thereof, transmitted to board 20′ from cache memory 38 to verify whether the data, or the portion thereof, is valid. These one or more tests may include, for example, cyclical redundancy checks and/or other tests. If processor 40′ determines that the data, or the portion thereof, is valid, processor 40′ may examine cache management tables (not shown) that may be stored in cache memory 38 and/or mass storage 28 that may contain information that may correlate respective dirty data, and locations thereof, stored in cache memory 38 with corresponding data, and locations thereof, stored in mass storage 28. Based upon the information in the cache management tables, processor 40′ may overwrite user data stored in mass storage 28 with corresponding valid dirty data stored in cache memory.

Thus, in summary, one system embodiment comprises a circuit board and a circuit card. The circuit board may comprise an interface. The circuit card may comprise circuitry, memory, and a power source. The circuit card may be capable of being coupled to the interface. When the circuit card is coupled to the interface, the circuitry may be capable of determining characteristics of electrical power and a clock signal being transmitted via the first interface to the circuitry. The characteristic of the electrical power that may be determined by the circuitry may comprise, for example, the level or magnitude of the electrical power. The characteristic of the clock signal that may be determined by the circuitry may comprise, for example, the magnitude of the slope of the clock signal. The circuitry may also be capable of determining, based at least in part upon whether a level of at least one of the characteristics is below a predetermined level, whether to transmit other electrical power from the power source and another clock signal to the memory. Advantageously, these features of this system embodiment may permit data stored in the memory to be preserved and/or refreshed despite an interruption in the supply of power and/or clock signals to the circuitry from the circuit board.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims.

For example, memory locations 318 and 330 have been described as being comprised in cache memory 38. However, locations 318 and 330 alternatively may be comprised in control logic 304, logic device 314, micro-controller 312, and/or a not shown memory in circuitry 56. Also, locations 318 and 330 may be comprised in non-volatile memory.

Additionally, when electrical power is being supplied from power source 300 to power control logic 304 and/or cache memory 38, micro-controller 312 may monitor the level of power being supplied by power source 300. If the level of the electrical power being supplied from power source 300 drops below the predetermined minimum power level sufficient to power adequately circuitry 56, micro-controller 312 may signal control logic 304 and cache memory 38. This may result in the de-activation of control logic 304 and cache memory 38. However, prior to de-activation of control logic 304 and cache memory 38, micro-controller 312 may store in non-volatile memory locations (not shown) one or more values that may indicate the level of power being supplied by source 300 has fallen below this predetermined minimum power level, control logic 304 and cache memory 38 are being de-activated, and the data stored in cache memory 38 is likely to be corrupted and/or invalid. After a subsequent powering-up of card 54, these one or more values may be retrieved and examined to determine that data stored in cache memory 38 is likely to be corrupted, invalid, and/or unusable.

Also, alternatively, comparator 316 may detect, e.g., in operation 404, when the level of the voltage being supplied to circuitry 56 via the power line in lines 310 is below a different predetermined minimum voltage level whose magnitude is higher than the magnitude of the predetermined minimum voltage level described previously. This different predetermined minimum voltage level may correspond to a power level that is greater than the minimum power level sufficient to actuate circuitry 56. This power and/or voltage level may be empirically determined to be likely to provide sufficient time for operations 404, 406, 408, 410, and 412 to be completed during the time period between detection of such power and/or voltage level and dropping of the magnitude of power and/or voltage being supplied to circuitry 56 via the power line in lines 310 (e.g., as a result of an interruption in the supply of actuating electrical power from board 20 to circuitry 56) to below a minimum magnitude of voltage and/or power sufficient to actuate properly circuitry 56.

Other modifications are also possible. Accordingly, the claims are intended to cover all such equivalents.

What is claimed is:

1. A method comprising:
determining, by circuitry that is capable of being coupled to an interface, characteristics of electrical power and a clock signal being transmitted via the interface to the circuitry; and
determining, by the circuitry, based at least in part upon whether a level of at least one of the characteristics is below a predetermined level, whether to transmit other electrical power and another clock signal to a memory comprised in the circuitry, the other electrical power and the another clock signal being generated by the circuitry.

2. The method of claim 1, wherein:
the at least one of the characteristics comprises a power level of the electrical power being transmitted via the interface to the circuitry.

3. The method of claim 1, wherein:
the at least one of the characteristics comprises a magnitude of a slope of the clock signal being transmitted via the interface to the circuitry.

4. The method of claim 1, further comprising:
de-coupling the circuitry from the interface;
coupling the circuitry to another interface; and
after the circuitry has been coupled to the another interface, verifying whether at least a portion of data stored in the memory prior to the coupling of the circuitry to the another interface is valid.

5. The method of claim 5, further comprising:
if the at least a portion of the data is verified as valid, storing the at least a portion of the data in mass storage.

6. The method of claim 1, wherein:
the at least one of the characteristics comprises a magnitude of a slope of the clock signal being transmitted to the circuitry via the interface; and
the determining of whether to transmit the other electrical power and the another clock signal is also based, at least in part, upon whether the magnitude of the slope remains below the predetermined level for longer than a predetermined amount of time.

7. An apparatus comprising:
circuitry capable of being coupled to an interface, determining characteristics of electrical power and a clock signal being transmitted via the interface to the circuitry, determining, based at least in part upon whether a level of at least one of the characteristics is below a predetermined level, whether to transmit other electrical power and another clock signal to a memory comprised in the circuitry, and generating the other electrical power and the another clock signal.

8. The apparatus of claim 7, wherein:
the at least one of the characteristics comprises a power level of the electrical power being transmitted via the interface to the circuitry.

9. The apparatus of claim 7, wherein:
the at least one of the characteristics comprises a magnitude of a slope of the clock signal being transmitted to via the interface to the circuitry.

10. The apparatus of claim 7, wherein:
the memory is capable of using the other electrical power to refresh data stored in the memory.

11. The apparatus of claim 7, wherein:
if the level of the at least one of the characteristics is below the predetermined level, the circuitry is also capable of preventing communication between the memory and a device via the interface.

12. The apparatus of claim 7, wherein:
the memory comprises cache memory to store data to be written to mass storage.

13. The apparatus of claim 7, wherein:
an In-line Memory Module (IMM) comprises the circuitry and power source; and
the interface comprises an IMM socket.

14. An article comprising:
a storage medium having stored thereon instructions that when executed by a machine result in the following:
determining, by circuitry that is capable of being coupled to an interface, characteristics of electrical power and a clock signal being transmitted via the interface to the circuitry; and
determining, by the circuitry, based at least in part upon whether a level of at least one of the characteristics is below a predetermined level, whether to transmit other electrical power and another clock signal to a memory comprised in the circuitry, the other electrical power and the another clock signal being generated by the circuitry.

15. The article of claim 14, wherein:
the at least one of the characteristics comprises a power level of the electrical power being transmitted via the interface to the circuitry.

16. The article of claim 14, wherein:
the at least one of the characteristics comprises a magnitude of a slope of the clock signal being transmitted to via the interface to the circuitry.

17. The article of claim 14, wherein:
if the level of the at least one of the characteristics is below the predetermined level, the instructions when executed by the machine also result in preventing of communication between the memory and a device via the interface.

18. A system comprising:
a first circuit board comprising a first interface; and
a circuit card comprising circuitry, memory, and a power source, the circuit card being capable of being coupled to the first interface, when the circuit card is coupled to the interface, the circuitry is capable of determining characteristics of electrical power and a clock signal being transmitted via the first interface to the circuitry, and determining, based at least in part upon whether a level of at least one of the characteristics is below a predetermined level, whether to transmit other electrical power from the power source and another clock signal to the memory.

19. The system of claim 18, wherein:
the first circuit board also comprises an input/output (I/O) controller.

20. The system of claim 18, wherein:
the circuit card comprises one of a dual in-line memory module (DIMM) and a single in-line memory module (SIMM).

21. The system of claim 18, further comprising:
a second circuit board comprising a second interface that is capable of coupling the first circuit board to the second circuit board.

22. The system of claim 21, wherein:
the a second circuit board includes a processor and a bus; and
the second interface comprises a bus interface that is capable of coupling the first circuit board to the bus.

23. The system of claim 18, wherein:
the first circuit board is capable of being coupled to mass storage.

24. The system of claim 23, wherein:
the mass storage comprises a redundant array of inexpensive disks (RAID).

25. The system of claim 24, wherein:
the memory comprises cache memory to store data to be written in the RAID.

26. The system of claim 25, wherein:
the first circuit board is capable of accessing the data.

27. The system of claim 18, wherein:
the circuitry also comprises one or more memory locations to store one or more values to indicate whether the circuitry is enabled to initiate the transmission of the other electrical power from the power source to at least the memory.
